(19) United States
(12) Patent Application Publication
(10) Pub. No.: US 2015/0181801 A1
(43) Pub. Date: Jul. 2, 2015

(54) DISPENSING SYSTEM FOR GRANULAR PRODUCTS

(71) Applicant: Cal G. Niemela, Chassell, MI (US)

(72) Inventor: Cal G. Niemela, Chassell, MI (US)

(21) Appl. No.: 14/586,212

(22) Filed: Dec. 30, 2014

Related U.S. Application Data
(60) Provisional application No. 61/923,025, filed on Jan. 2, 2014.

(51) Int. Cl. A01C 17/00; A01K 5/00; H04N 5/225; E01H 10/00

(52) U.S. Cl. CPC A01C 17/001; E01H 10/007; A01K 5/00; H04N 5/2252

(57) ABSTRACT

A dispensing system store and selectively dispenses granular products, such as corn, nuts, grain, or animal feed pellets, or for inedibles such as roadway salt, sand, gravel, fertilizer, seeds, or the like. The system includes a main housing with a storage hopper and, typically, at least one other internal area or region for additional components, such as a camera or a cable spool. The storage hopper has a lower dispensing portion and an upper filling portion. A flexible securing member secures the main housing to a tree or other support surface. The securing member is extendable, retractable, and lockable relative to storage hopper by a retractor at the housing, and a distal end is selectively attachable to a receiving portion at the main housing, so that the securing member may be looped around a tree. Optionally, a game camera is mountable in the main housing.

### CROSS REFERENCE TO RELATED APPLICATION

The present application claims the priority benefit of U.S. provisional application, Ser. No. 61/923,025, filed Jan. 2, 2014, which is hereby incorporated herein by reference in its entirety.

### FIELD OF THE INVENTION

The present invention is directed to devices for storing and distributing granular products, such as wild game feed, road salt, fertilizers, seeds, and the like.

### BACKGROUND OF THE INVENTION

Baiting wild game is a common practice before and during hunting seasons, and is a technique used to encourage game animals to frequent a particular hunting area. Where baiting is allowed, hunters will often set up a bait station where they may provide different types of bait or attractant (i.e. corn, sugar beets, cabbage, carrots, apples, etc.) depending on the type of game being hunted. Known corn-dispensing bait stations are relatively portable and can be set up in remote locations. Some of the smaller corn-dispensing bait stations can be hung from a tree branch, while other larger-capacity units are designed to be free standing. Once installed, the bait station is filled with corn and is ready to dispense the bait.

While the functionality of known bait dispensing devices is generally adequate, they are in some cases difficult to use. For example, when a hunter selects a baiting location in a remote location that is not readily accessible to a motorized vehicle, then the bait dispensing device and the bait must be transported manually. This is usually done by first carrying the dispensing device to the location and then returning to manually carry a pail or sack of corn to the baiting location. Most corn comes packaged in 50 lb sacks that, when carried manually, makes the process laborious and difficult. Carrying and re-filling the dispensing device must be done on a regular basis to maintain the frequency at which game animals return to the feeding station, so the work of setting up and re-filling the device can be substantial.

### SUMMARY OF THE INVENTION

The present invention provides a dispensing system that is readily transportable and is capable of selectively distributing or dispensing granular products, such as corn, nuts, grain, or animal feed pellets, such as for use as a bait station for hunting. Optionally, the system may be used for non-food products such as roadway salt, sand, gravel, fertilizer, grass or other plant seeds, or the like. The system includes a main housing with a storage hopper and generally at least one other internal area or region for mounting additional components in a secure and protected manner. The storage hopper has a lower dispensing portion and an upper filling portion. A flexible securing member, such as a metal cable, is arranged to secure the main housing to a tree or other support surface. The securing member is extendable, retractable, and lockable relative to storage hopper by a retractor at the housing, and a distal end of the securing member is attachable to a receiving portion at the main housing, so that the securing member can be looped around the tree and used to support the dispensing unit. Optionally, a game camera may be securely mounted to the main housing. The dispensing portion may be fitted with an on-demand distribution unit (e.g. gravity-fed), or with a motorized or manually-operated spreader that can be operated automatically or according to a desired schedule, or triggered based on detected events such as the presence of game animals.

Accordingly, the dispensing system of the present invention provides a readily transportable and serviceable (e.g., refillable) unit for storing and selectively dispensing granular products such as bait foods, and for replenishing the supply of granular product as needed. The system is securable against theft, damage, or tampering, and may include an optional camera for recording wildlife activity and deterring theft or vandalism to the unit.

These and other objects, advantages, purposes, and features of the present invention will become apparent upon review of the following specification in conjunction with the drawings.

### BRIEF DESCRIPTION OF THE DRAWINGS

FIG. 1 is a perspective view of a dispensing system for granular products in according with the present invention, shown mounted on a tree or pole and in use as a deer feeding station;

FIG. 2 is a partially-exploded front perspective view of the dispensing system of FIG. 1, in which a lid and camera are shown separated from a main housing;

FIG. 3 is another partially exploded front perspective view of the dispensing system of FIG. 1, in which the lid and a retractor are shown separated from the main housing;

FIG. 4 is another front perspective view of the main housing of the dispensing system of FIG. 1, showing installation of a lock for securing a lid, in which the lid has been omitted for clarity;

FIG. 5 is another front perspective view similar to FIG. 4, but with the lock and lid both installed at the main housing;

FIG. 6 is a top plan view of the main housing of the dispensing system of FIG. 1, in which the lid has been omitted to show internal structure and components;

FIG. 7 is another front perspective view of the dispensing system of FIG. 1, in which operation of a retractor crank handle is demonstrated;

FIG. 8 is another front perspective view of the dispensing system of FIG. 1;

FIG. 9 is a top plan view of the dispensing system of FIG. 1, in which the extension of a flexible securing member is demonstrated;

FIG. 10 is a right side elevation of the dispensing system of FIG. 1, showing interior features and surfaces thereof;

FIG. 11 is a left side elevation of the dispensing system of FIG. 1;

FIG. 12 is a front elevation of the dispensing system of FIG. 1;

FIG. 13 is a front perspective view of a user carrying a backpack-style storage and dispensing sack that contains the dispensing system of FIG. 1;

FIGS. 14A and 14B are front perspective views of another dispensing system configured for the attachment of interchangeable dispensing units, and showing the attachment of an on-demand gravity-actuated dispenser;

FIGS. 15A and 15B are front perspective views of the dispensing system for interchangeable dispensing units, showing the attachment of a motorized broadcast spreader;

FIGS. 16A and 16B are front perspective views of the dispensing system for interchangeable dispensing units, showing the attachment of a manually-operated broadcast spreader;

FIG. 17 is a front perspective view of a user carrying the dispensing system fitted with the manually-operated broadcast spreader of FIG. 16B; and

FIG. 18 is a rear perspective view of the dispensing system and motorized broadcast spreader, similar to that of FIG. 15B, shown mounted at the rear of a vehicle and fitted with a remote user-actuatable control.

### DESCRIPTION OF THE PREFERRED EMBODIMENTS

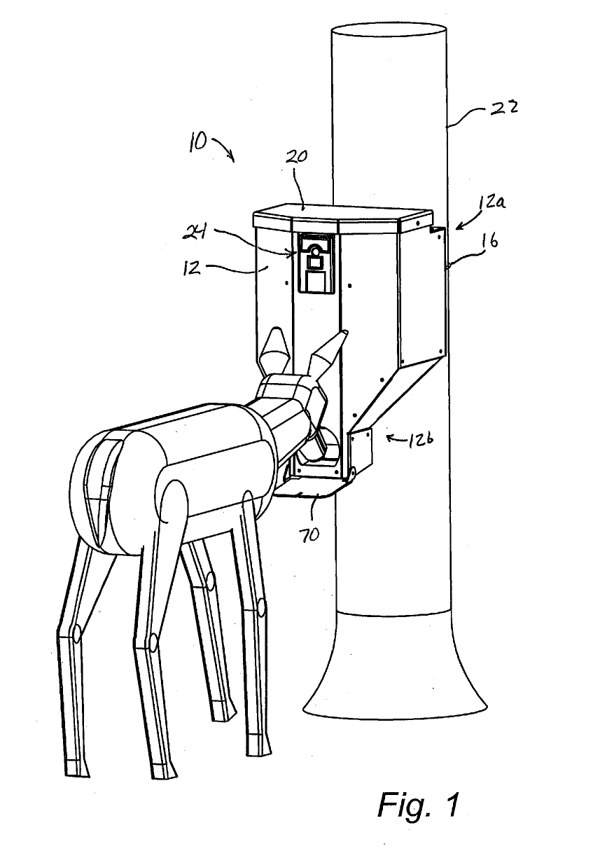

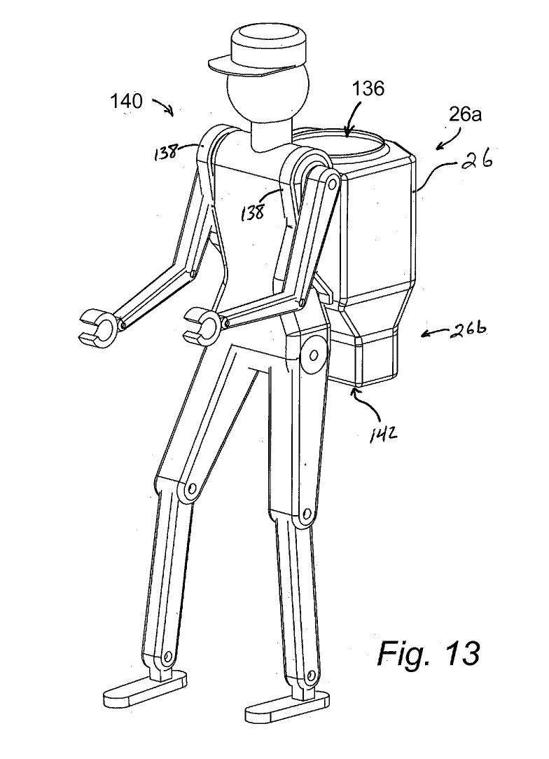

Referring now to the drawings and the illustrative embodiments depicted therein, a dispensing system 10 is configured for containing and dispensing or distributing granular products such as game feed (e.g., corn, nuts, grains), seeds (e.g., grass seed), rock salt, sand, gravel, or the like. Dispensing system 10 includes a main housing 12 defining a storage hopper 14, a flexible securing member 16, and a retractor 18, such as shown in FIGS. 1-3. Main housing 12 is enclosed by a cover or lid 20, and is securable to a tree or pole 22 (FIG. 1) using securing member 16 and retractor 18, such as for use as a game feeder. Dispensing system 10 is lockable and is constructed in a manner that resists tampering and/or damage by unauthorized persons or large game (e.g., bear, moose, elk), and may include provisions for installing a camera 24 for monitoring usage of the dispensing system. As will be more fully described below, dispensing system 10 may include a carrying sack 26 (FIG. 13) that is also usable for carrying loads of granular products and refilling storage hopper 14, and dispensing system 10 may also be configured for the broadcast-spreading of granular products from a fixed location and/or from a vehicle or a person at which the system is optionally mountable or supportable.

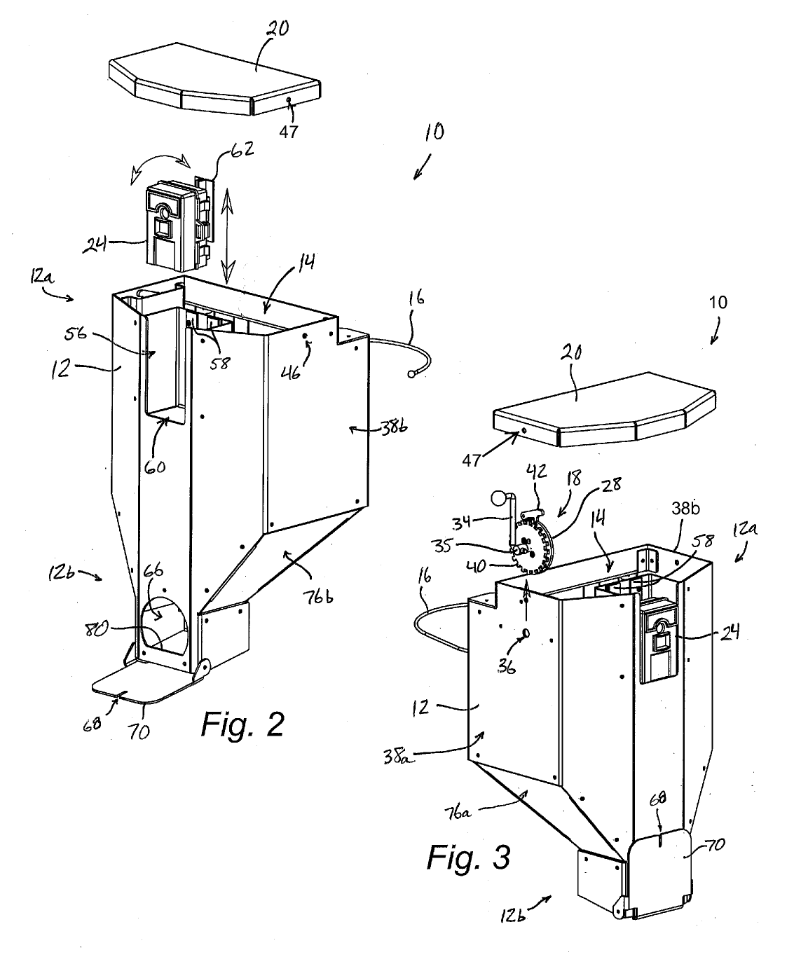

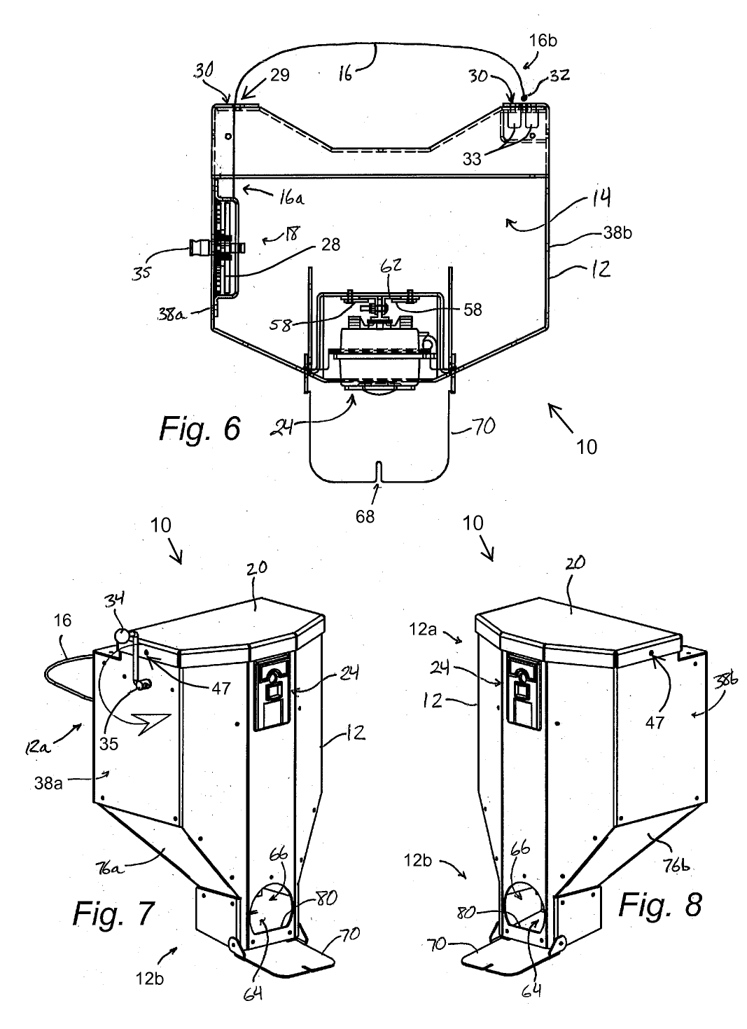

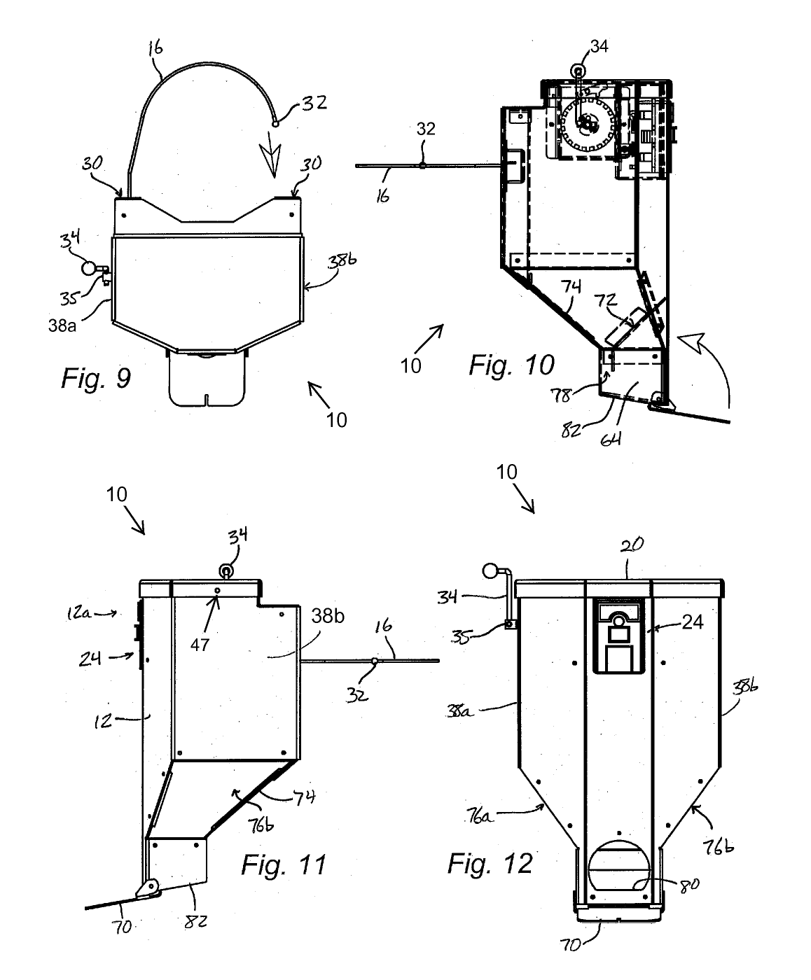

Main housing 12 includes an upper access and filling region 12a and a lower dispensing portion or region 12b. With cover 20 removed, upper region 12a of main housing 12 provides access to storage hopper 14, retractor 18, and camera 24, such as shown in FIGS. 2, 3, and 6. A proximal portion 16a of flexible securing member 16 is wound around a spool 28 of retractor 18 (FIGS. 3 and 6), and passes through an opening 29 formed in a rear surface 30 of housing 12 (FIG. 6). Flexible securing member 16 may be unwound from spool 28 as it is extended therefrom, and a ball-end 32 at a distal end portion 16b is used to secure flexible securing member 16 to housing 12 via engagement with a retaining feature such as a key-hole slot, a pair of spaced-apart catch fingers 33, or the like, which are formed or established at or just inside of the rear surface 30, opposite the side on which retractor 18 is mounted (FIGS. 6 and 9). Optionally, the slot, fingers 33, or other retaining feature is accessible only from inside of main housing 12 when cover 20 is removed, for added security. Flexible securing member 16 may be a metal cable for increased security, or may be a chain, a woven strap, or substantially any sufficiently strong, flexible material, and it will be appreciated that substantially any type of connection or coupling may be used to secure the distal end portion 16b of cable 16 to main housing 12, without departing from the spirit and scope of the present invention.

Once ball-end 32 is secured at the catch fingers 33 inside the housing rear surface 30, spool 28 may be wound in a retraction direction, such as shown in FIG. 7, in order to tighten cable 16 and secure dispensing system 10 against tree or pole 22. In the illustrated embodiment, spool 28 is rotatable in the cable-retracting or tightening direction by engaging a hand crank 34 with a retractor spindle 35 that extends through an opening 36 formed in a right sidewall 38a of main housing 12 (FIG. 3), and manually rotating the hand crank 34 (FIG. 7). Once the tension of cable 16 is set as desired, hand crank 34 may be removed and carried with the user. Retractor 18 includes a ratcheting mechanism in the form of a toothed gear 40 that rotates with spool 28 relative to a pawl 42 (FIG. 3), which is operable to selectively lock spool 28 against rotation in the cable-extending direction.

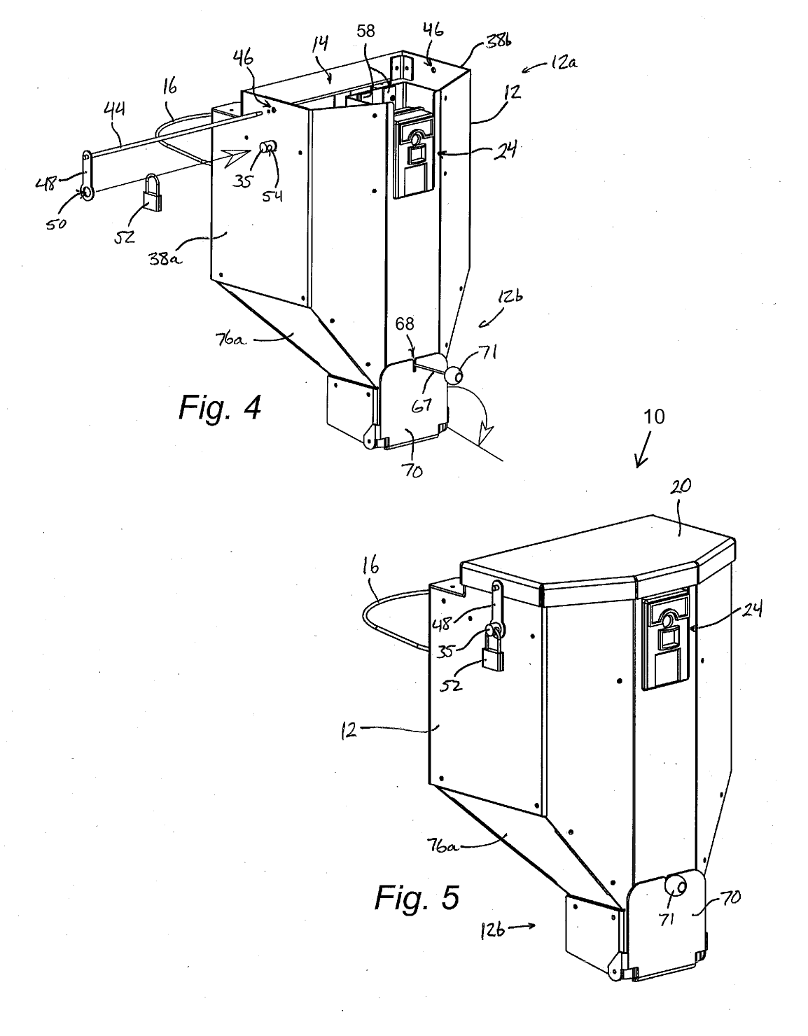

Optionally, and as shown in FIGS. 4 and 5, cover 20 is securable and lockable in place at the upper access and filling region 12a of main housing 12 with a locking rod 44 that is inserted through respective holes 46 formed in right sidewall 38a and a left sidewall 38b of main housing 12, with corresponding holes 47 (FIGS. 2, 3, 7, 8, and 11) formed opposite vertical walls of cover 20. In the illustrated embodiment, a tab 48 extends downwardly from a proximal end of locking rod 44 and defines an aperture 50 that receives spindle 35 of retractor 18 (FIGS. 4 and 5). A padlock 52 or other securing device may then be coupled to spindle 35 through a bore 54 that also receives hand crank 34 when operating retractor 18. Padlock 52 thus prevents removal of locking rod 44, which secures cover 20 against removal from main housing 12. When cover 20 is installed and secured, it thus prevents or inhibits unauthorized access to storage hopper 14, retractor 18, and camera 24.

Main housing 12 further defines a camera-receiving portion or chamber 56 that is outside of storage hopper 14, where camera 24 is removably supported (FIGS. 2-4). Camera-receiving chamber 56 includes a pair of support rails 58 and defines a front opening 60 in which a front portion of camera 24 is received. Support rails 58 are spaced apart and mounted at a rear portion of chamber 56 so as to form a track that is configured to be slidingly engaged by a generally T-shaped slide member 62 to which camera 24 is mounted, such as shown in FIGS. 2, 4, and 6. Optionally, slide member 62 includes a threaded screw that is configured to threadedly engage a correspondingly-threaded bore formed or established along a rear surface of camera 24. With cover 20 removed and camera 24 coupled to slide member 62, camera 24 may be readily removed and replaced in camera-receiving chamber 56 by sliding the slide member 62 along support rails 58. Camera 24 may be a weather-resistant “trail cam” type device that is manually triggered (such as via a wireless remote control) or automatically triggered by detection of game animals by movement, an infrared sensor, or the like. Camera 24 may include electrical storage batteries, a strobe flash, a solar charging panel, an infrared light emitter, a repositionable lens to permit adjustment of a viewing area of the camera, and/or other features common to outdoor imaging systems.

In the illustrated embodiment, lower dispensing portion or region 12b of main housing 12 is generally funnel-shaped in order to direct the granular product contained in storage hopper 14 to a dispensing chamber 64 having a front opening 66 for dispensing granular food product such as corn, alfalfa pellets, nuts, grain, or substantially any pellet-like and flowable animal food product. Referring to FIGS. 1, 2, and 6-12, a closure flap 70 is pivotably mounted to dispensing chamber 64 below opening 66, and is movable between an open position in which the flap is angled downwardly from horizontal, and a closed position in which the flap 70 covers opening 66 to prevent dispensing granular food product (FIGS. 3-5), such as during transport or during other periods when it is undesirable to dispense food. In the open position of FIGS. 1-3 and 6-12, flap 70 may deflect granular food product a short distance laterally away from the dispensing system 10 as the granules exit opening 66. Flap 70 may be secured in the raised (closed) position by an elastic cord 67 that is attached to a front panel of main housing 12 and passes through a slot 68 formed in a distal end of flap 70, with a ball 71 or other gripping portion positioned at the end of elastic cord 67 (FIGS. 4 and 5). Ball 71 is normally drawn against the underside of flap 70 in the raised position (FIG. 5), and may be manually pulled outwardly (FIG. 4) to permit flap 70 to be lowered to the dispensing position of FIGS. 2 and 6-12.

As shown in FIG. 10 (and with additional reference to FIGS. 11 and 12), an internal funnel panel 72 cooperates with a rear funnel panel 74 and two side funnel panels 76a, 76b to channel the granular food product into a narrow vertical passageway 78 that, in turn, leads to dispensing chamber 64. A forward lower lip 80 (FIG. 12) defines the lower extent of opening 66 and inhibits granular food product from flowing freely out of dispensing chamber 64. This permits a buildup of a certain amount of the granular food product in dispensing chamber 64 along a sloped floor 82, so that the built-up granular food product blocks or inhibits the unrestricted flow of additional granular food product through passageway 78. Once a quantity of the built-up granular food product is removed from dispensing chamber, such as by animals eating from the chamber, the level of built-up granular food product drops in the vicinity of passageway 78, aided by the slope of floor 82, and permits additional food to be dispensed from storage hopper 14 through passageway 78 and into dispensing chamber 64. Thus, lower dispensing portion 12b of main housing 12 acts as an on-demand game feeder when flap 70 is opened.

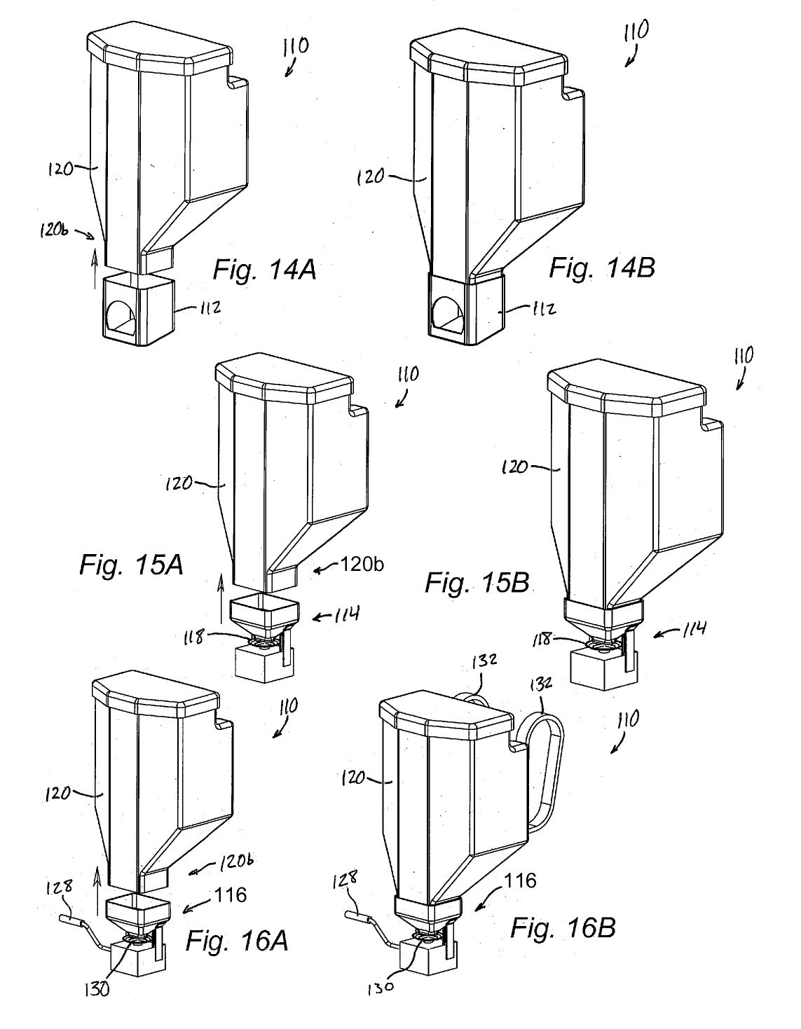

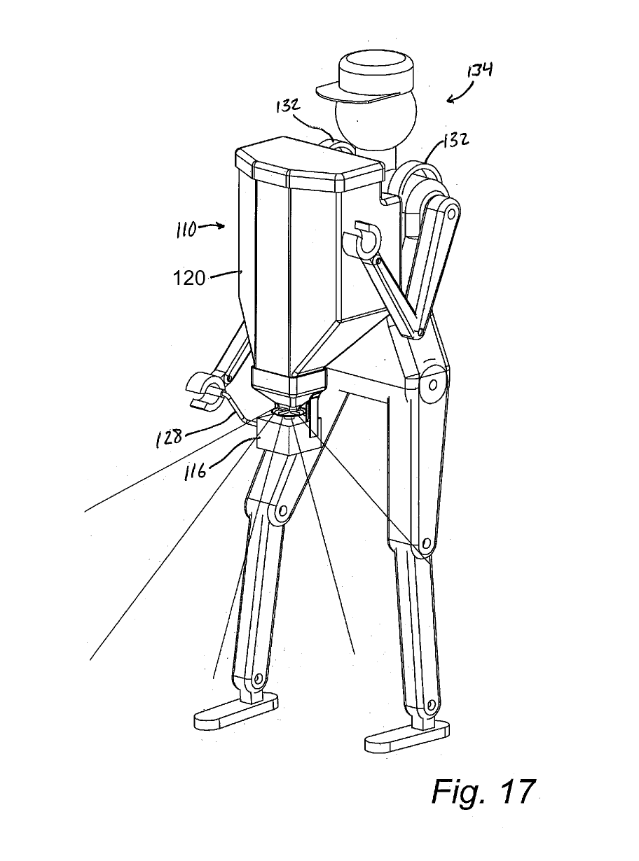

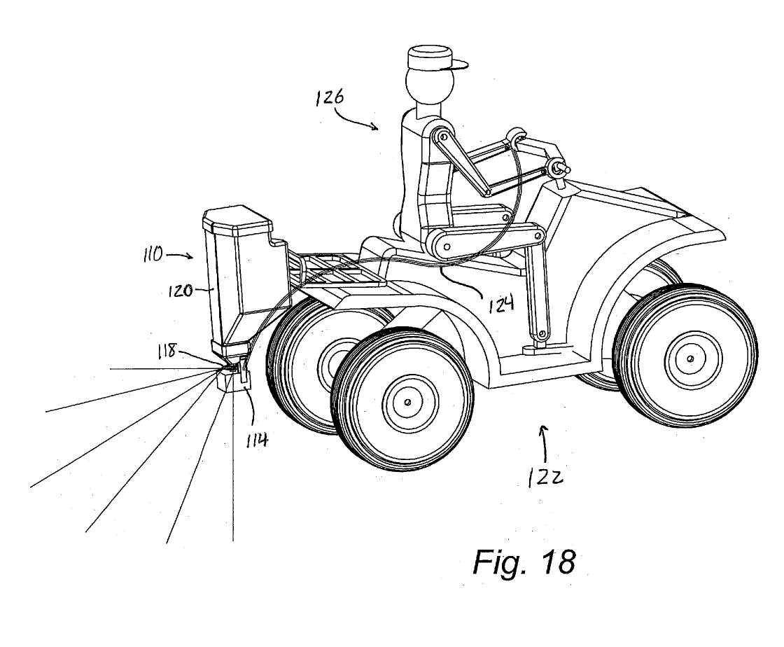

Optionally, an alternative dispensing system 110 is functionally similar or identical to dispensing system 10 when fitted with a replaceable dispensing unit 112 (FIGS. 14A and 14B) that operates in the substantially the same manner as the lower dispensing portion 12b that is described above. However, dispensing system 110 is configured to be interchangeably fitted with dispensing unit 112, or one of many different possible alternative dispensing units such as a motor-driven broadcast spreader 114 (FIGS. 15A, 15B, and 18) or a manually-driven broadcast spreader 116 (FIGS. 16A-17). Motor-driven broadcast spreader 114 has an battery-powered electric motor that drives a disc-shaped spinner 118, which slings granular product radially outwardly when the spinner is rotating and the granular product is dropped onto the spinner from a lower funnel portion 120b of a main housing 120. Motor-driven broadcast spreader 114 may be operated continuously or until battery power and/or granular product are depleted, or may be operated sporadically or on a predetermined schedule or frequency, such as with a timer, or may be automatically or manually switched on in response to game detected within the vicinity of the dispensing system 110. Optionally, the dispensing system 110 with motor-driven broadcast spreader 114 may be mounted on a vehicle 122 and used to distribute salt, sand, fertilizer, seed, animal feed, or the like, such as shown in FIG. 18. In vehicle-mounted applications, motor-driven broadcast spreader may be fitted with a remote control line 124 that enables the vehicle operator 126 to activate the spreader 114 as desired while operating the vehicle 122 to which dispensing system 110 is mounted, and it may be powered by the vehicle's electrical system.

Manually-driven broadcast spreader 116 operates in substantially the same way as motor-driven broadcast spreader 114, but includes a hand crank 128 for operating its spinner 130 (FIGS. 16A-17). Optionally, main housing 120 may be fitted with a pair of shoulder straps 132 that enable the dispensing system 110 to be worn on the front of an operator 134, such as shown in FIG. 17. The operator 134 may walk around to different locations and manually turn hand crank 128 to distribute granular product as desired, using the speed of hand crank 128 (and correlating speed of spinner 130) to control the width of the distribution area. Other types of dispensing units are also envisioned, which may similarly be interchangeable with other dispensing units of the same overall dispensing system 110. For example, a game-actuated dispensing unit may have an actuatable feed tray that is operable to release a portion of granular animal feed from the storage hopper upon actuation of the feed tray by an animal, such as during a feeding session as shown in FIG. 1.

Referring now to FIG. 13, carrying sack 26 defines a storage chamber that is primarily accessed through a top opening 136, which is sufficiently large (when fully opened) for main housing 12 to pass through. When fully expanded, the storage chamber of carrying sack 26 is shaped in a manner than generally conforms to the outer proportions of dispensing system 110, including a wider upper portion 26a where the main housing upper portion 12a is located, and a narrower lower portion 26b corresponding to the main housing lower portion 12b. Carrying sack 26 includes a pair of shoulder straps 138 to facilitate carrying the loaded carrying sack by a wearer 140, such as shown in FIG. 13.

Not only is carrying sack 26 sized and shaped to carry dispensing system 10, but it is also configured to store a quantity of granular product (e.g., feed corn) that may be used to re-supply or re-fill the storage hopper 14 of a dispensing system 10 that has already been placed in a desired location, such as at a tree, pole, support stand, or vehicle. The narrower lower portion 26b of carrying sack may serve as a funnel, while an openable and closeable opening 142 at the bottom of lower portion 26b allows the user to selectively discharge the granular contents of carrying sack into the open storage hopper 14. However, in the illustrated embodiment, narrower lower portion 26b will not permit dispensing system 10 to pass through opening 142. Thus, carrying sack 26 provides a dual function of facilitating the carrying and placement of dispensing system 10 in remote locations, and permitting the subsequent carrying and dispensing of consumable granular products to the dispensing system that has already been placed in a desired location.

With the dispensing system 10 securely positioned in the carrying sack 26, the user can open the top opening 136, remove the dispensing system top cover 20 and pour in the corn or other granular product into storage hopper 14. After the storage hopper 14 is fully charged with granular product and the cover 20 is securely fastened, the top opening 136 is closed, such as with a draw string, zipper, or flap. The dispensing system 10 may be transported in the carrying sack 26 in a vehicle to the closest point of access to the desired location for distribution or dispensing of the granular product. Using the shoulder straps 138, the dispensing system 10 can be slung onto the user's shoulders much like a backpack, allowing the user to comfortably walk to the desired baiting or other type of distribution location.

When used for baiting, once the dispensing system 10 is in the desired general location it is removed from the carrying sack 26, positioned on tree 22 at the desired feeding height, and then securely attached to the tree using the built-in cable attachment system described above. After dispensing system 10 is attached to the tree 22 and with the top cover 20 in position and locked, the entire system is secure and substantially theft-resistant and tamper-resistant. The user may then leave the area with the empty carrying sack 26 and wait for the game animals to locate and begin feeding on the corn or other granular food product. Depending on the activity and number of animals using the feeder, it will be necessary to re-fill the storage hopper 14 from time to time. When this is required, the user fills the empty storage sack 26 with additional granular feed, and carries it on his back (or front, if desired) using shoulder straps 138. The bottom opening 142 is selectively openable to direct and release the new feed into the storage hopper 14. This may be accomplished while the dispensing system 10 is positioned on the tree 22 or other support structure (using a stepladder if necessary), or by first lowering the system from the tree or structure and supporting the system on the ground or other low surface during the filling procedure.

Dispensing systems 10, 110 are generally made of animal-resistant and impact-resistant materials, which preferably resist cracking even in cold temperatures. For example, sheet metal (e.g., aluminum alloy) or fiber-reinforced resinous plastics may be sufficiently strong, resilient, resistant to outdoor elements, and resistant to excessive embrittlement in subzero temperatures. In the illustrated embodiments, the storage hopper 14 is sufficiently large to contain at least 50 lbs. of whole-kernel dried corn, which is a standard size (in the U.S.) for pre-packaged feed corn used as animal bait. It may be preferable to size the storage hopper to contain somewhat more than a standard package size, so that the contents of an entire new package may be added to the hopper prior to the hopper becoming totally empty. However, it will be appreciated that the storage hopper 14 may have substantially any desired capacity. The use of camera 24 in the relatively protected region of camera-receiving portion 56 both protects the camera and reduces the likelihood of theft of the camera and of tampering with the dispensing system by unauthorized persons or aggressive large animals. The overall system is thus generally resistant to theft, vandalism, and damage caused by wildlife such as bears.

Thus, the dispensing system of the present invention provides a readily transportable unit for storing and selectively dispensing a granular product, and for replenishing the supply of granular product as needed. The system is secured against theft, damage, or tampering, and may include an optional camera for recording wildlife activity and deterring theft or vandalism to the unit. Although the dispensing system is primarily shown and described for use as a wild game feed station, or for distributing granular products (e.g., road salt, fertilizer, seed) onto the ground, it will be appreciated that there are many other potential applications, such as distributing metered amounts of animal feed at fish ponds or poultry farms, or any other application where the controlled release and/or spreading of flowable solids (e.g. pellets, granules, or the like) is desired.

Changes and modifications in the specifically-described embodiments can be carried out without departing from the principles of the present invention, which is intended to be limited only by the scope of the appended claims, as interpreted according to the principles of patent law including the doctrine of equivalents.

1. A dispensing system for granular products, said dispensing system comprising:
a main housing defining a storage hopper having a lower dispensing portion and an upper filling portion;
a lockable lid that is securable to said main housing and configured to selectively prevent access to said upper filling portion;
a flexible securing member having proximal and distal portions, wherein said flexible securing member is configured for lockably securing said main housing to a tree or support surface, said flexible securing member being extendable and retractable relative to said storage hopper;
a retractor mounted inside said main housing and external to said storage hopper, said retractor configured to support at least said proximal portion of said flexible securing member, and selectively operable to (i) pay out said flexible securing member, (ii) retract said flexible securing member, and (iii) lock said flexible securing member to limit or prevent extension thereof; and
a receiving portion at said main housing, said receiving portion configured to receive and secure said distal portion of said flexible securing member.

2. The dispensing system of claim 1, wherein said flexible securing member comprises a cable, said distal portion of said flexible securing member comprises an enlarged end portion, and said receiving portion comprises one chosen from a keyhole slot and a pair of spaced-apart catch fingers for receiving and retaining said enlarged end portion.

3. The dispensing system of claim 1, wherein said retractor comprises a spool and a ratcheting mechanism that is operable to selectively (i) permit said flexible securing member to be wound and unwound on said spool, and (ii) limit or prevent said flexible securing member from being wound and unwound on said spool.

4. The dispensing system of claim 3, further comprising a hand crank configured to engage said retractor to permit manual rotation of said spool, wherein said hand crank is engageable with said retractor from outside said main housing, and said hand crank is separable from said retractor during periods of non-use.

5. The dispensing system of claim 1, further in combination with a storage and dispensing sack comprising:
a main storage chamber configured to receive said dispensing system and store a quantity of a granular product when said dispensing system is not positioned in said main storage chamber;
an upper opening configured for insertion and removal of said dispensing system from said main storage chamber;
a lower opening that is selectively closeable and openable, wherein said lower opening is configured to selectively dispense the granular product from said main storage chamber when in an open configuration; and
at least one carrying strap configured to facilitate carrying said storage and dispensing sack by a user.

6. The dispensing system of claim 5, wherein said lower opening of said storage and dispensing sack is sized so that said dispensing system cannot pass through said lower opening when said lower opening is in the open configuration.

7. The dispensing system of claim 1, further comprising a dispensing unit coupled to said lower dispensing portion of said hopper, wherein said dispensing unit is configured to receive a granular product from said lower dispensing portion of said hopper, and is operable to discharge the granular product.

8. The dispensing system of claim 7, wherein said dispensing unit comprises a motor-driven broadcast spreader and a remote control operable to selectively actuate said motor-driven broadcast spreader, and wherein said main housing of said dispensing system is configured for mounting on a vehicle.

9. The dispensing system of claim 7, wherein said dispensing unit comprises a manually-driven broadcast spreader and said dispensing system comprises a pair of shoulder straps coupled to said main housing, and wherein said dispensing system is supportable along a front of a user with said manually-driven broadcast spreader positioned for manual operation by the user.

10. The dispensing system of claim 7, wherein said dispensing unit comprises an on-demand dispenser, and wherein said on-demand dispenser is a game-actuated dispenser defining an opening and comprising an actuatable feed tray that supports granular animal feed and is operable to release a portion of the granular animal feed from said storage hopper upon actuation of said feed tray by an animal.

11. The dispensing system of claim 10, wherein said dispensing unit comprises a pivotable flap that is movable between an open position in which said opening of said game-actuated dispenser is accessible by the animal, and a closed position in which said opening is covered by said flap and inaccessible by the animal.

12. The dispensing system of claim 1, further comprising a camera supported in said main housing.

13. The dispensing system of claim 12, wherein said camera comprises a repositionable lens to permit adjustment of a viewing area of said camera.

14. The dispensing system of claim 12, wherein said main housing defines a camera-receiving portion outside of said storage hopper, said camera-receiving portion configured to permit insertion and removal of said camera.

15. The dispensing system of claim 14, further comprising a slide member coupled to said camera, and wherein said camera-receiving portion of said main housing comprises a track configured to be slidably engaged by said slide member.

16. The dispensing system of claim 15, wherein said lid covers said camera-receiving portion to thereby secure said camera against removal from said housing.

17. The dispensing system of claim 16, wherein said lid is configured to simultaneously preclude access to said storage hopper, said camera-receiving portion, and said retractor.

18. A dispensing system for granular products, said dispensing system comprising:
a main housing defining (i) a storage hopper having a lower dispensing portion and an upper filling portion, (ii) a camera-receiving chamber outside of said storage hopper, and (iii) a retractor chamber outside of said storage hopper;
a lockable lid that is securable to said main housing and configured to selectively prevent access to said upper filling portion, said camera-receiving portion, and said retractor chamber;
a flexible securing member having proximal and distal portions, wherein said flexible securing member is configured for lockably securing said main housing to a tree or support surface, wherein said flexible securing member is extendable from and retractable into said retractor chamber;
a retractor mounted inside said retractor chamber, said retractor configured to support at least said proximal portion of said flexible securing member, and selectively operable to (i) pay out said flexible securing member, (ii) retract said flexible securing member, and (iii) lock said flexible securing member to limit or prevent extension thereof; and
a receiving portion at said main housing, said receiving portion configured to receive and secure said distal portion of said flexible securing member.

19. The dispensing system of claim 18, further comprising:
a camera supported in said camera-receiving chamber;
a slide member coupled to said camera; and
a track at said camera-receiving chamber, wherein said track is configured to be slidably engaged by said slide member;
wherein said camera and said slide member are slidably removable from said camera-receiving chamber upon removal of said lockable lid.

20. The dispensing system of claim 18, further in combination with a storage and dispensing sack comprising:
a main storage chamber configured to receive said dispensing system and store a quantity of a granular product when said dispensing system is not positioned in said main storage chamber;
an upper opening configured for insertion and removal of said dispensing system from said main storage chamber;
a lower opening that is selectively closeable and openable, wherein said lower opening is configured to selectively dispense the granular product from said main storage chamber when in an open configuration; and
at pair of shoulder straps configured to facilitate carrying said storage and dispensing sack by a user.
